(19) United States
(12) Patent Application Publication
(10) Pub. No.: US 2009/0276470 A1
(43) Pub. Date: Nov. 5, 2009

(54) Data Processing System And Method

(76) Inventors: Rajesh VIJAYARAJAN, Bangalore (IN); Srividya Ramanathan, Bangalore (IN); Rajani G. K., Bangalore (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/140,278

(22) Filed: Jun. 17, 2008

(30) Foreign Application Priority Data
May 5, 2008 (IN) 1108/CHE/2008

(51) Int. Cl. G06F 17/30

(52) U.S. Cl. 707/202; 707/E17.001

(57) ABSTRACT

A method of rotating a current log file, comprising associating a first file system data structure associated with the current log file with a backup log file, and associating a second file system data structure associated with the backup log file with the current log file.

### RELATED APPLICATIONS

Benefit is claimed under 35 U.S.C. 119(a)-(d) to Foreign application Serial No. 1108/CHE/2008 entitled “DATA PROCESSING SYSTEM AND METHOD” by Hewlett-Packard Development Company, L.P., filed on 5^{th} May, 2008, which is herein incorporated in its entirety by reference for all purposes.

### BACKGROUND TO THE INVENTION

Operating systems, such as, for example, UNIX and the like, generate log files that record actions and events related to hosted services and applications. Utilities are available that regularly manage the logfiles, which assists in limiting the amount of storage space demanded by such log files.

An approach to managing logs within a log file regularly schedules a log rotation task that renames an existing log file and creates a new, zero length log file for subsequent logged actions and events. A service or application that logs actions and events must then use the new log file, for example by closing the old log file and opening the new log file. This may lead to downtime of the service or application, and may require the service or application to be programmed to be aware of the log file rotation. It is also common for the log rotation task to compress old log files (for example, the renamed log files) and to delete log files after a certain age or after a rotation cycle threshold has been reached.

For example, one skilled in the art will be familiar, from BSD, for example, with the following operating system command:
newsyslog[-Fnrv][-f config_file][-a directory][file . . . ]

which rearranges the files so that “logfile” is empty, “logfile.0” contains the most recent or the last period's logs, “logfile.1” contains the next oldest period's logs, and so on, up to a user specified number of archived logs.

When starting, newsyslog reads a configuration file to determine the logs that may potentially be archived. Conventionally, the configuration file is /etc/newsyslog.conf. Each line of the configuration file contains information about a particular log file that should be handled by newsyslog. The fields of the configuration file are well known to those skilled in the art. In particular, those fields include a size field that influences the maximum size of the log file.

It is an object of embodiments of the invention to at least mitigate one or more of the problems of the prior art.

### BRIEF DESCRIPTION OF THE DRAWINGS

Embodiments of the invention will now be described by way of example only, with reference to the accompanying figures, in which:

FIG. 1 shows an example of a portion of a known computer system;

FIG. 2 shows an example of log files within a file system;

FIG. 3 shows an example of a method for rotating a log file according to embodiments of the invention;

FIG. 4 shows an example of log files before associated data structures are updated;

FIG. 5 shows an example of log files after associated data structures are updated; and

FIG. 6 shows another example of a method according to embodiments of the invention.

### DETAILED DESCRIPTION OF EMBODIMENTS OF THE INVENTION

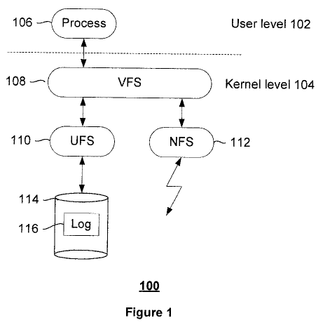

Referring to FIG. 1, there is shown a computer system 100 as is well known within the art. The computer system 100 comprises, for illustrative purposes only, a user level 102 and a kernel level 104. The user level 102 comprises a user process 106 that is able to perform file system operations (not shown) via a virtual file system (VFS) 108 within the kernel level 104 of the computer system 100. The virtual file system 108 maps generic, or virtual, file system operations to specific file system operations that are effected via one or more than one file system. In the illustrated embodiment, two file systems are illustrated, which are UFS 110 and NFS 112. The UFS 110 is illustrated as having associated storage 114 such as, for example, an HDD or some other form of non-volatile storage. The storage 114 is used to store a log 116.

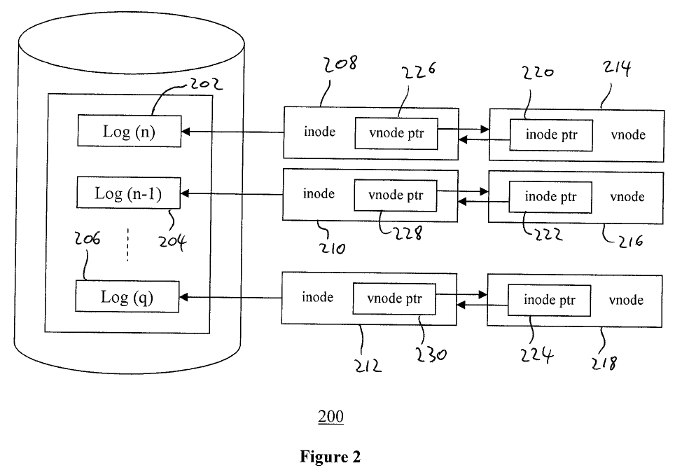

FIG. 2 illustrates an arrangement 200 of the user log 116 in greater detail. The log 116 comprises a number files 202 to 206 that represent a current log file 202 and a number of rotated or older log files 204 and 206. Each log file comprises an associated inode 208 to 212 that identifies the location of the associated log file within the file system (for example, within the storage 114). When the log files are open, the open log files have an associated file descriptor (not shown) and an associated vnode 214 to 218. Each vnode has an associated inode pointer 220 to 224. The inode pointer identifies the inode of the open file. Each inode has an associated vnode pointer 226 to 230. The vnode pointer identifies the vnode that points to the inode.

The first log file 202 is the youngest log file. This file is used by a service or application to log actions and events. The service or application logs actions and events by appending data to the youngest log file 202, hereinafter called the current log file. Subsequent log files such as log files 204 and 206 are progressively older, with the last log file 206, that is, log (q), being the oldest retained log file.

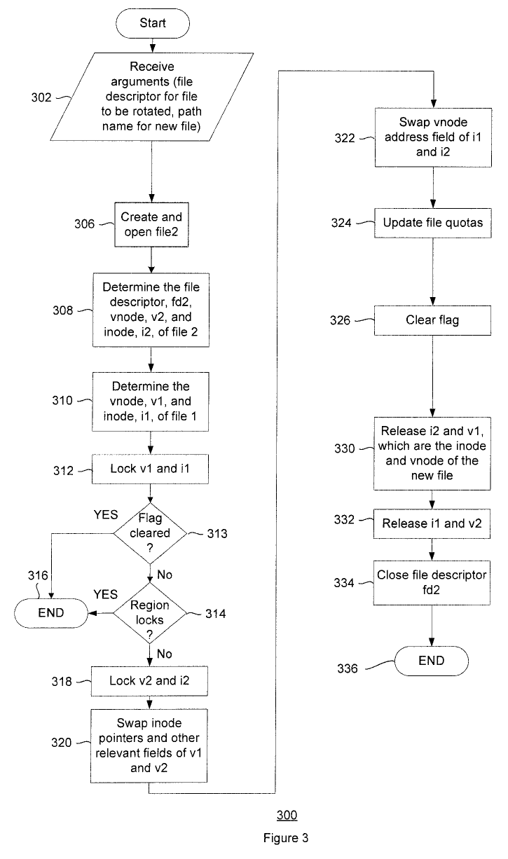

The virtual file system 108 shown in FIG. 1 presents an API for implementing or effecting log rotation. For example, the API may be presented as a function such as rotate( ). FIG. 3 shows a flowchart 300 for log rotation, that is, for such an API, according to an embodiment of the invention. At step 302, arguments are received via the API, for example from a service or application that calls the rotate( ) function using those arguments. In the illustrated embodiment, the arguments provide a file descriptor of a file to be rotated (for example, the current log file) and a filename. The filename (for example, “file2”) is the name of the file to which the current log file would be renamed in conventional log file rotation systems.

A new log file is created and opened at step 306 using the filename argument, for example “file2”. Optionally, a test may be performed to determine whether or not the new log file already exists, and if this is the case, the length of the file is truncated to zero. Next, step 308 identifies the file descriptor, fd2, vnode, v2, and inode, i2, of the newly created log file. The vnode, v1, and inode, i1, of the current log file are determined at step 310. Step 312 imposes a lock on the vnode, v1, and inode, i1, associated with the current log file. Next, a check is made in step 313 as to whether a flag has been cleared. If the flag has been cleared, the procedure 300 ends at step 316. The flag is used to ensure that multiple threads do not simultaneously rotate a single log file, and is explained in more detail later in this description.

If the flag has not been cleared, the procedure 300 continues from step 313 to step 314 where an optional determination is made regarding whether or not a lock, such as, for example, a region lock, is extant regarding the vnode, v1, of the current log file. However, one skilled in the art appreciates that locks such as, for example, region locks should not normally need to be held because, in writing log files, all writers to the log file (for example, services and applications) are expected to open the file only in append mode. Therefore, region locks may not be needed for synchronization. If such a region lock is in force, the method 300 ends at step 316. The vnode v1 and inode i1 may also be unlocked and the file descriptor fd2 closed.

If there are no region locks, or there is no check for region locks, the inode, i2, and vnode, v2, of the newly created log file (for example, “file2”, associated with file descriptor fd2) are locked at step 318.

At step 320, the inode pointers of the vnodes v1 and v2 are swapped. At step 322, the vnode pointers of the inodes i1 and i2 are swapped. Thus, at the end of step 322, the vnode v1 of the current log file points to the inode i2 of the newly created log file. Thus, the current log file is effectively “reset” to zero length. The vnode v2 of the newly created log file points to the inode i1 of the current log file. Thus, the current log file is effectively renamed to the file name of the newly created log file (for example, “file2”), and is no longer the file that is appended to by services and applications logging actions and events.

Therefore, effectively, the current log file becomes an older, unused, rotated log file with a different file name, while a new current log file is created. The new current log file has the same vnode as the older log file, and so no updating of file descriptors is required within applications. Thus the effective creation and use of the newly created current log file happens in a way that is transparent to the services and applications. As a result, the services and applications experience less or no downtime as a result of the process and also may not require programming to be aware of any log rotation process.

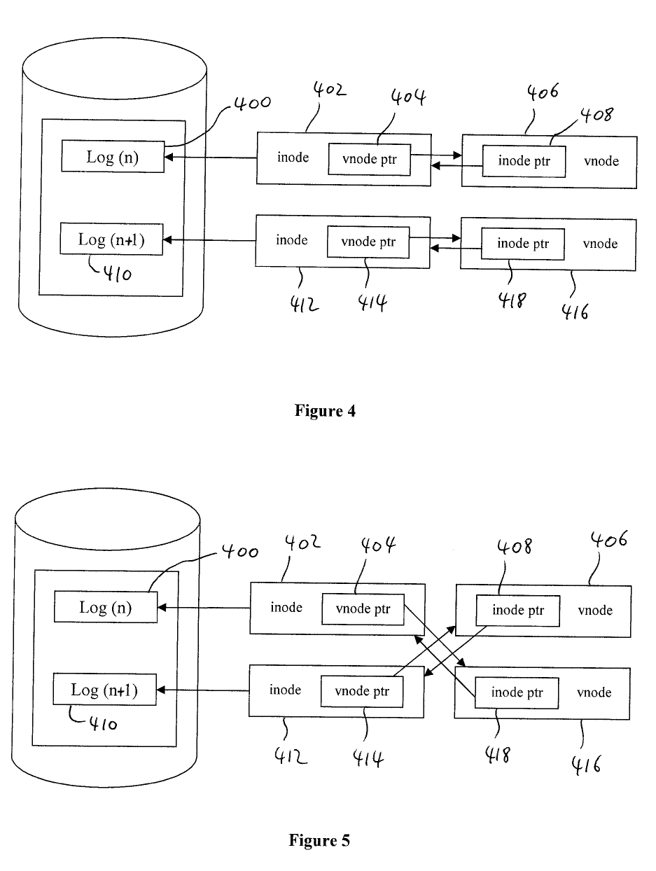

FIGS. 4 and 5 illustrate the steps 320 and 322 of the method 300. FIG. 4, before the steps 320 and 322 shows a current log file 400 that is associated with an inode 402. As the current log file 400 is open, the inode 402 has a vnode pointer 404 that points to a vnode 406. The vnode 406 has an inode pointer 408 that points to the inode 402.

Also illustrated is newly created log file 410 and its associated inode 412. The inode 412 includes a vnode pointer 414 that points to the vnode 416 of the newly created log file 410. The vnode 416 includes an inode pointer 418 that points to the inode 412.

FIG. 5 illustrates the position after the steps 320 and 322 of the method 300 have been carried out. The inode pointer 408 of the vnode 406 of the current log file now points to the inode 412 of the newly created log file. Therefore, effectively, the newly created log file 410 is the current log file. Any service or application that accesses the current log file through the vnode 406 accesses the newly created log file 410. The inode pointer 418 of the vnode 416 has been changed to point to the inode 402. Thus, the log file 400 (previously the current log file) is accessed through a different vnode, being the vnode 416, and a different filename.

Referring back to FIG. 3, the method 300 proceeds from step 322 to an optional step 324 where quotas for the new current log file and the rotated log file (the previous current log file) are determined and updated. This is described in more detail later in this document.

Following from step 322 or 324 as appropriate, the flag is cleared in step 326. Clearing of the flag indicates that the rotation has been completely successfully by the thread. Then, the locks associated with i2 and v1, which are the inode and vnode of the new current log file, are released in step 330. The locks associated with i1 and v2, which are the inode and vnode of the rotated previous current log file (now an old log file), are released in step 332. The file descriptor (not shown) associated with the newly created log file is closed at step 334. The method 300 then ends at step 336.

In certain embodiments of the invention, a quota is associated with a log file. The quota specifies the maximum file size that is permitted for the log file. The quota for a log file may be specified in a number of ways. As an example, the quota for a log file may be specified as follows. On file creation, using open( ) for example, a flag O_FQUOTA is specified, causing a quota to be associated with the created log file. Commands, for example operating system commands, may then be provided to query or set the quota. In certain embodiments, the file size quota may be stored as an attribute within the inode associated with the file.

The size quota may be enforced by checking whether a requested write to the file will exceed the quota, and if not, allowing the write to proceed. For example, operating system commands may be provided with the ability to enforce the file size quota. Thus, for example, if the size of a log file is approaching the quota, certain writes may be disallowed as they would cause the size of the file to exceed the quota. However, smaller writes from the same or another service or application may subsequently proceed if the requested write is smaller, that is the requested write does not cause the file size to exceed the quota.

An example of an implementation is provided as follows. If a thread's write request would cause the log file to exceed the quota if allowed (or if the log file already exceeds the quota), then the write does not go ahead and the write( ) routine returns a certain error number (for example EQUOTA). The thread is then expected to invoke the procedure 300 shown in FIG. 3, for example using an operating system call. During execution of the procedure 300, other write requests may be made by other threads, and these write requests can be blocked until the procedure 300 completes successfully (i.e. reaches step 336), at which point the write requests can be allowed to proceed. It may be possible that a second thread may invoke the procedure 300 while the procedure 300 is already executing, having been invoked by a first thread. This may be addressed by including a flag with each inode that indicates when the procedure 300 is being carried out for that inode. The flag is set when a write using that inode fails due to a quota breach or potential quota breach, and cleared when the procedure 300 completes successfully at step 336. Other threads that invoke the procedure 300 will wait at step 312 until the flag is cleared, as other locks will be in force until this point. These other threads executing the procedure 300 will then check in step 313 whether the flag has been cleared, and if the flag has been cleared by some other thread the other threads will end the procedure 300 at step 316, clearing locks and closing file descriptors as appropriate. If the flag has not been cleared, then the procedure continues from step 313 to step 314.

In embodiments of the invention where file size quotas are used, step 324 of the method 300 of FIG. 3 is carried out. In this step, a check is made of the old log file (the previous current log file) to determine if it has an associated quota. If it has, the quota of the old log file is determined and is then assigned to the new current log file. If desired, the quota of the old log file can then be changed, for example by clearing the quota to remove any file size limit associated with the old log file.

In certain embodiments of the invention, an application or service may open the current log file in a mode other than append mode. For example, the file may be open in a mode that allows writing at any point within the file. In such an embodiment, an offset is maintained (for example, by the operating system) that indicates the point in the file which would be next written to by the application or service. When carrying out the method 300 of FIG. 3 to rotate the log file, this offset may be reset to zero such that the application or service next writes to the start of the newly created, zero length current log file.

In certain embodiments, the point at which the size of a current log file exceeds a predetermined size (for example, a desired maximum size) may be determined, for example by polling the size of the current log file. If the polling determines that the size of the current log file exceeds the predetermined size, the method 300 of FIG. 3 may be invoked to rotate the current log file to an old log file of another name and to create a new current log file. This approach may be used, for example, even where the operating system does not provide the facility to check whether certain writes will cause the file size to exceed a predetermined size (for example, a file size quota). This approach may also be used, for example, in situations where applications cannot be changed to open files using O_FQUOTA to specify a quota associated with a newly created log file. In other embodiments, however, the operating system may determine when a write would exceed the quota and invoke the method 300 before this write is allowed.

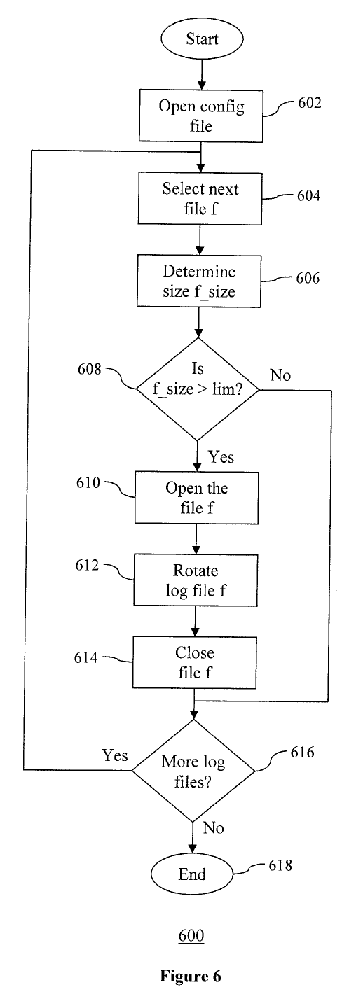

An example 600 of this process is shown as a flow chart in FIG. 6. The process 600 starts at step 602 where a configuration file (for example, logrotate.conf) is opened. The configuration file provides a list of log files that may need rotating if they have exceeded a predetermined size. Next, a file f is selected from the configuration file. The files may be selected, for example, in the order in which they are presented in the configuration file or using some other selection method.

Then, in step 606, the size f_size of the file is determined. In step 608, the file size f_size is compared with a log file size limit, lim. The limit lim may apply to all of the log files in the configuration file or may be specific to the log file f. For example, the limit lim for each log file or all the log files may be specified in the configuration file.

If the file size f size exceeds the limit lim, the log file must be rotated. Therefore, the method 600 proceeds from step 608 to step 610 where the file f is opened, for example using fd=open (f). Then, in step 612, the log file f is rotated. For example, the process 300 shown in FIG. 3 is carried out in respect of the log file f. Once the log file f is rotated in step 612, the file f is closed in step 614. The method then proceeds to step 616.

If the determination in step 608 indicates that the file size f_size is less than the limit lim, then no log file rotation is required, and so the method 600 proceeds from step 608 to step 616.

In step 616, a determination is made as to whether there are any more log files indicated by the configuration file that have not been selected. If so, then the method returns to step 604 where the next log file is selected. If not, then the method 600 ends at step 618.

The process 600 may be carried out each time it is desired to check whether any of the log files indicated by the configuration file need to be rotated. For example, the process 600 may be executed at regular intervals. Thus, the size of each of the log files is polled to determine whether rotation is required.

In the above description, an example is provided where pointers are exchanged within file system data structures such that the same file pointer points to a new file. However, in certain file systems, file system data structures may be associated with each other in similar ways as the associations between inodes and vnodes, whereby associated file system data structures do not include pointers to each other. Instead, some other mechanism is used to associate file system data structures with each other. In such situations, embodiments of the invention may provide that the associations between file system data structures are manipulated to give effect to log file rotation.

Some embodiments of the invention provide new fields, ‘v_rotation count’ in the vnode of a log file, and ‘f_rotation_count’ in the file table entry of a thread that has opened the log file. When the file is first opened, v_rotation_count is initialized to zero. The rotation procedure (for example, the rotate( ) API) increments v_rotation_count of the vnode for the file being rotated on each successful rotation. When the file is opened by a thread for reading, v_rotation_count is copied to f_rotation_count of the thread's file table entry if the file is already open (for example, v_rotation_count has already been opened by another thread), else f_rotation_count is set to zero. Whenever read( ) is invoked by the thread reading the log file, f_rotation_count is compared with v_rotation_count. If the two values do not match, then it indicates that the file has been rotated since the last read by that thread. In this case, for example, the read( ) fails and returns a suitable error code (for example, EROTATE). The application may be expected to handle the error. How the error is handled may be based on the nature of the application. For example, if the application only requires the latest data from a log file, the application needs to reopen the same file (i.e. it needs to open the new, rotated log file with the newest log data). If the application needs to read all the data that has been logged, it needs to open the older file and read from it using the same offset it was using before the log file was rotated. Once the end of the file (EOF) is encountered, the original file (i.e. the new, rotated log file) can be opened and read from the beginning. Thus, an application is aware that a log file has been rotated since it last read from the log file, and can act accordingly.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of rotating a current log file, comprising associating a first file system data structure associated with the current log file with a backup log file, and associating a second file system data structure associated with the backup log file with the current log file.

2. A method as claimed in claim 1, wherein associating the first file system data structure with the backup log file and associating the second file system data structure with the current log file comprises swapping a first pointer in a first file system data structure associated with the current log file with a second pointer in a second file system data structure associated with a backup log file.

3. A method as claimed in claim 1, wherein the first pointer comprises a first inode pointer to a first inode, the first file system data structure comprises a first vnode, the second pointer comprises a second inode pointer to a second inode and the second file system data structure comprises a second vnode.

4. A method as claimed in claim 3, comprising swapping a first vnode pointer to the first vnode in the first inode with a second vnode pointer to the second vnode in the second inode.

5. A method as claimed in claim 1, comprising monitoring a size of the current log file, and performing the association based on the monitoring.

6. A method as claimed in claim 1, comprising receiving a request to write data to the current log file, determining whether the write would cause the current log file to exceed a predetermined file size, performing the association if the write would cause the current log file to exceed the predetermined file size, and allowing the write to proceed.

7. A system for rotating a current log file, the system arranged to associate a first file system data structure associated with the current log file with a backup log file, and associate a second file system data structure associated with the backup log file with the current log file.

8. A system as claimed in claim 7, arranged to associate the first file system data structure with the backup log file and associate the second file system data structure with the current log file by swapping a first pointer in a first file system data structure associated with the current log file with a second pointer in a second file system data structure associated with a backup log file.

9. A system as claimed in claim 8, wherein the first pointer comprises a first inode pointer to a first inode, the first file system data structure comprises a first vnode, the second pointer comprises a second inode pointer to a second inode and the second file system data structure comprises a second vnode.

10. A system as claimed in claim 9, arranged to swap a first vnode pointer to the first vnode in the first inode with a second vnode pointer to the second vnode in the second inode.

11. A system as claimed in claim 7, arranged to monitor a size of the current log file, and perform the association based on the monitoring.

12. A system as claimed in claim 7, arranged to receive a request to write data to the current log file, determine whether the write would cause the current log file to exceed a predetermined file size, perform the association if the write would cause the current log file to exceed the predetermined file size, and allow the write to proceed.

13. A computer program comprising instructions for implementing the method of claim 1 or the system of claim 7.

14. Computer readable storage storing a computer program as claimed in claim 13.
